(19) United States
(12) Patent Application Publication
(10) Pub. No.: US 2020/0017219 A1
(43) Pub. Date: Jan. 16, 2020

(54) INFLATABLE AISLE-SPANNING DOUBLE BED

(71) Applicant: JetBed, Inc., San Diego, CA (US)

(72) Inventor: Gerald Bosstick, Rancho Santa Fe, CA (US)

(21) Appl. No.: 16/507,417

(22) Filed: Jul. 10, 2019

Related U.S. Application Data
(60) Provisional application No. 62/696,121, filed on Jul. 10, 2018.

(51) Int. Cl. B64D 11/06; B64D 11/00

(52) U.S. Cl. CPC B64D 11/0604; B64D 2011/0069; B64D 11/00

(57) ABSTRACT

The invention generally relates to bed structures having an inflatable and/or collapsible/deflatable component. More particularly, it relates to aisle-spanning double bed configurations capable of supporting multiple users in a comfortable sleeping position.

### CROSS REFERENCE TO RELATED APPLICATIONS

This application claims the benefit of U.S. Provisional Application No. 62/696,121 filed on Jul. 10, 2018, which is incorporated herein by reference in its entirety as though fully set forth herein.

### FIELD OF THE INVENTION

The present invention relates to bed structures having an inflatable and/or collapsible/deflatable component. More particularly, it relates to aisle-spanning double bed configurations capable of supporting multiple users in a comfortable sleeping position.

### BACKGROUND TO THE INVENTION

Long voyages induce passengers to nap or to sleep for long periods of time. Even the most luxurious of aircraft, and many other craft, have generally failed to provide a sleeping surface where a typical adult can stretch out their full length and rest on a horizontal surface. When such a horizontal surface is described herein, it refers to a surface generally horizontal with a cabin floor of the aircraft. The prior art has offered solutions which appear to be impractical or excessively expensive. A simple solution has been to eliminate seats in favor of a space long enough to install a bed structure. The amount of horizontal space required for installation of a bed structure in an aircraft has made this solution impractical. Equally impractical has been adaptation of aircraft passenger seats so that mechanical manipulation results in a bed structure. The high cost of aircraft passenger seats, i.e., usually from $100,000 to $140,000, requires an undue investment in a mechanically convertible passenger seat or seats, an investment which may not be recoverable, or which can dissuade the business jet purchaser from making such an investment.

An unfortunate feature of mechanically convertible seats in the prior art to form a bed structure has been their lack of comfort. The articulated and segmented nature of aircraft passenger seats into at least two major curved surfaces, i.e., the seat back and the seat cushion, prevents their use in forming a flat bed surface. Moving these two parts of an aircraft passenger seat into a pseudo-flat surface eliminates the ability of a passenger to lay on their side or stomach, in that the surfaces are formed in to conform to a human back and seat.

A prior patent (U.S. Pat. No. 7,845,718) provided a bed that transformed facing individual aircraft passenger seating into a horizontal double bed surface adapted to provide users with a flat surface upon which users can lie on their back, side or stomach. That patent is incorporated herein by reference, in its entirety.

Aircraft seating for passengers is usually laid out with all passengers seated side by side, with all passenger seats facing forward. A typical aircraft passenger seat includes a set of supports anchored to a cabin floor, whereupon is secured a seat bottom securing a seat cushion. The seat cushion is an important aspect of passenger orientation on the seat itself. The top surface of the seat cushion declines rearward from a front edge to a back edge of the seat cushion so that a passenger is urged against a curved seat back when seated. The change in elevation can be slight (such as about one inch change in elevation for coach seats) or can be very accentuated (2-4 inches for executive or first-class seats). Seat declination in aircraft passenger seating serves a safety function, in that a passenger is less likely to be ejected from the seat when a safety belt is secured across the passenger's lap. As such, seat declination from front to rear on the seat cushion is an important aspect of aircraft passenger seating. However, this provides a challenge when designing a horizonal bed surface that rests on the seats.

A cost of efficiency in aircraft passenger seating layout is that most passengers do not find it preferable. Arranging the seats side by side and front to back creates a perception of a space that is cramped and confining. In response, some aircraft manufacturers have created a space-inefficient solution in placing two aircraft passenger seats face-to-face, one facing to the front of the aircraft and one facing a rear of the aircraft. The two seats are necessarily spaced apart by a substantial distance to prevent stretched legs of two face-to-face passengers from contacting each other. The very purpose of providing two seating sections separated by an aisle is for luxury and comfort. It would do little good to provide such seating sections separated by an aisle, where the occupants were interfering with each other's leg space. Similarly, the very structure of the seats themselves should provide an above average level of postural and cushioning comfort to complement the luxury appointments of the face-to-face seating arrangement. As such, the seat cushions of seating sections that face each other across an aisle typically provide very substantial cushioning and a rather substantial seat cushion rearward declination to match, again providing a challenge when designing a horizontal bed surface.

Furthermore, in some craft, there can be a bench-type seating section such as a sofa or a couch on one side of the aircraft. For example, there can be face-to-face seating on one side of the aircraft and a bench-type seating on the other side of the aircraft with the sofa facing the face-to-face seating across an aisle. In some craft, there can be two bench-type seating sections facing each other across an aisle. This can be the case with multiple single seats on one or both sides of the aisle, and/or with a bench-type seating section on one or both sides of the aisle, and these seating sections can exist in any combination.

### SUMMARY OF THE INVENTION

Embodiments of the invention relate to aisle-spanning double (or larger) bed configurations capable of supporting multiple users in a comfortable sleeping position.

Some embodiments of the invention relate to a device for forming a bed surface that can include (a) an inflatable foundation block including a top surface, a bottom surface, two end walls and two side walls, wherein the bottom surface can be capable of being supported by a floor surface between two face-to-face passenger seats in a craft, the end walls and side walls rise to support the top surface, the top surface can have a width about that of the face-to-face passenger seats, the top surface can have a length from a top of one end wall to a top of another end wall and can equal about a distance between opposing front edges of the face-to-face passenger seats, and the entire foundation block can be adapted to be collapsed in a stowage state and expanded in an installed state, wherein the top surface of the foundation block can extend between the opposing front edges of the seat cushions of the passenger seats in the installed state; and (b) an inflatable foundation pad including a top surface, a bottom surface, two end walls and two side walls, wherein the top surface can span an aisle of the craft between the face-to-face passenger seats and a second seating section, wherein the bottom surface of the inflatable foundation pad is capable of being supported by the top surface of the foundation block, top surfaces of the two face-to-face passenger seats, and a top surface of the second seating section.

In some embodiments, the foundation pad is covered with a top pad of uniform thickness. In some embodiments, the foundation pad is covered with two adjacent top pads.

In some embodiments, the bed surface is at least the size of a double bed.

In some embodiments, the foundation block is capable of supporting weight by way of multiple structure internal baffles.

In some embodiments, the multiple structure internal baffles connect to an inside surface of the top surface, the bottom surface and the side walls.

In some embodiments, the passenger seats include an elevated front edge and a back part at a lower elevation, and wherein the device can further include filler pads wherein each filler pad has dimensions such that a top surface thereof is substantially co-planar with the top surface of the foundation block when a conforming underside of each filler pad rests upon the passenger seat in the installed state.

In some embodiments, each filler pad can be rotatably fixed to each of two edges of the foundation pad which are adjacent to the front edge in the installed state.

In some embodiments, the top pad and filler pad can be enclosed in a flexible fabric envelope and can be rotatably connected by an integral fabric section.

In some embodiments, each filler pad has a width about equal to face-to-face passenger seat width and has a length about equal to a distance from the front edge to the back part.

In some embodiments, the foundation block and foundation pad are separate units that are capable of being deflated and stowed in a carrying case with the filler pads; wherein the carrying case can be a height of less than half of the face-to-face passenger seat.

In some embodiments, the second seating section is a bench-like seat such as a sofa.

In some embodiments, the second seating section is a second set of face-to-face passenger seats and wherein the device includes a second foundation block oriented to fit between the seats of said second set.

Some embodiments of the invention relate to a device for forming a bed surface that can include an inflatable foundation pad comprising a top surface, a bottom surface, two end walls and two side walls, wherein the top surface spans an aisle of a craft, two seating sections on opposite sides of the aisle, wherein the bottom surface of the inflatable foundation pad is capable of being supported by the top surface of the seating surfaces.

In some embodiments, the foundation pad can be covered with a top pad of uniform thickness. In some embodiments, the foundation pad can be covered with two adjacent top pads.

In some embodiments, the bed surface is at least the size of a double bed.

In some embodiments, the seating surfaces can include an elevated front edge and a back part at a lower elevation, and wherein the device further comprises filler pads and wherein each filler pad has dimensions such that a top surface thereof is substantially co-planar with the bottom surface of the foundation pad when a conforming underside of each filler pad rests upon the seating surfaces in the installed state.

### BRIEF DESCRIPTION OF THE DRAWINGS

FIG. 1 (a) depicts a top view of an embodiment in of the invention with an inflated foundation block, inflated foundation pad, two top pads, and two filler pads as placed when the bed is in an installed state and (b) depicts a bottom view of the embodiment of FIG. 1.

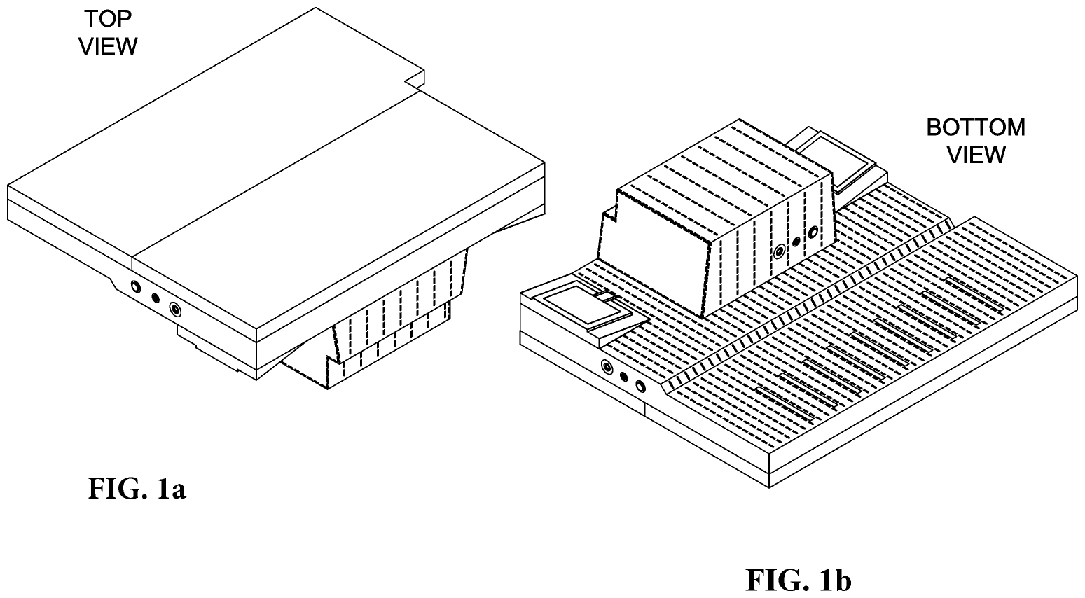

FIG. 2 depicts a filler pad being stowed in a carrying case.

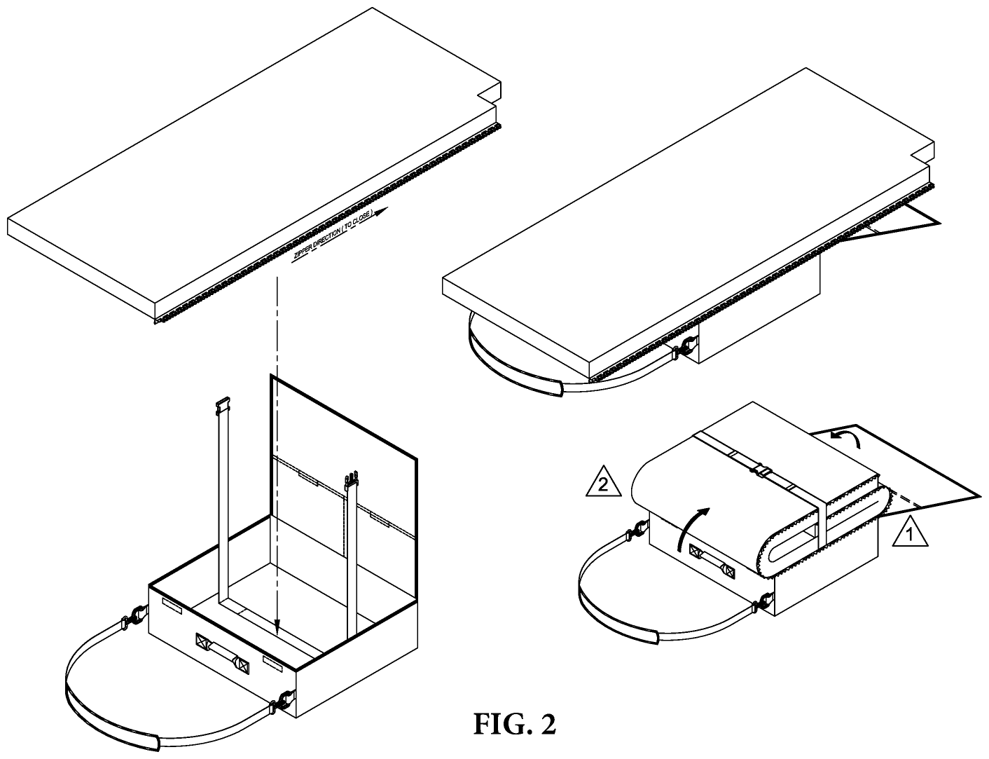

FIG. 3 depicts a filler pad being stowed in a carrying case.

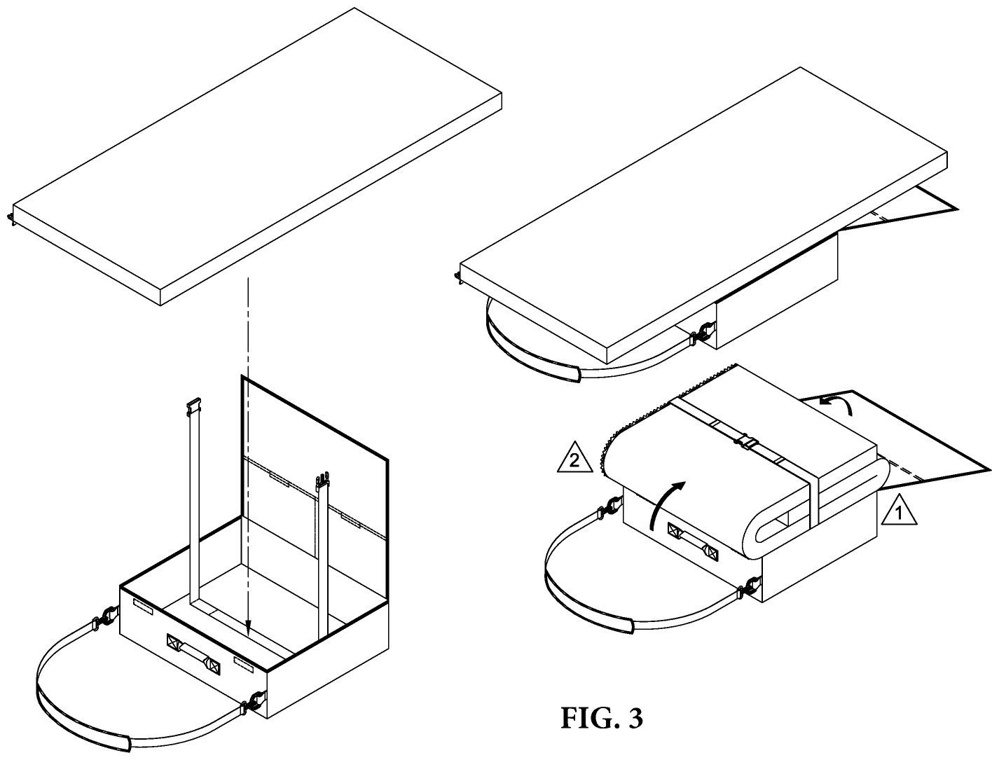

FIG. 4 depicts a foundation block, foundation pad, and filler pads being stowed in a carrying case.

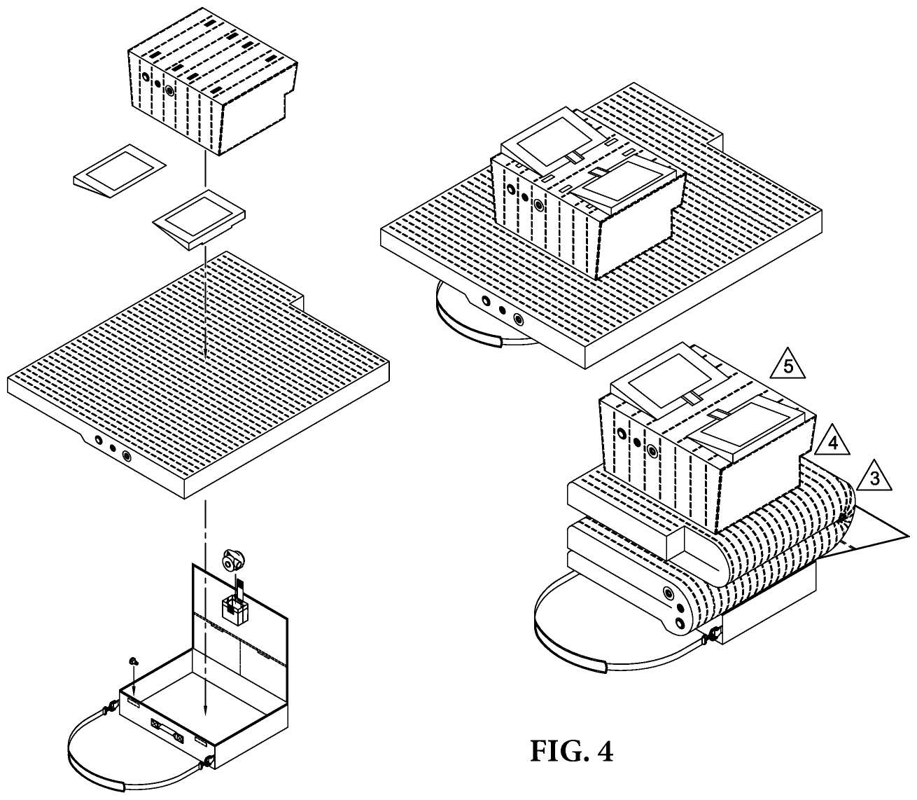

FIG. 5 (a) depicts a top view of a foundation block and (b) depicts a bottom view of a foundation block.

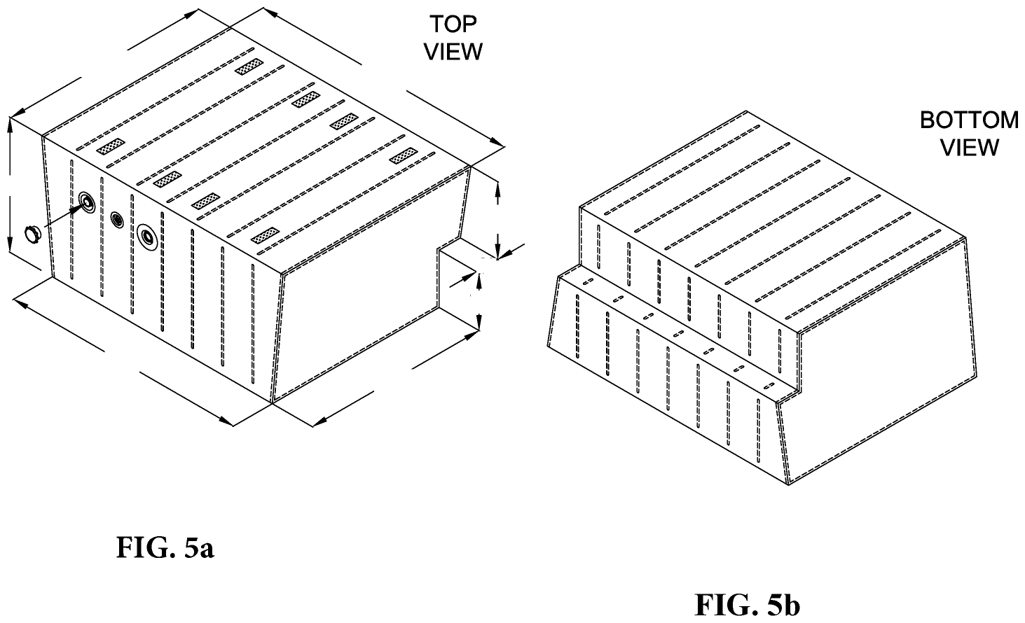

FIG. 6 (a) depicts a top view of a foundation pad and (b) depicts a bottom view of a foundation pad.

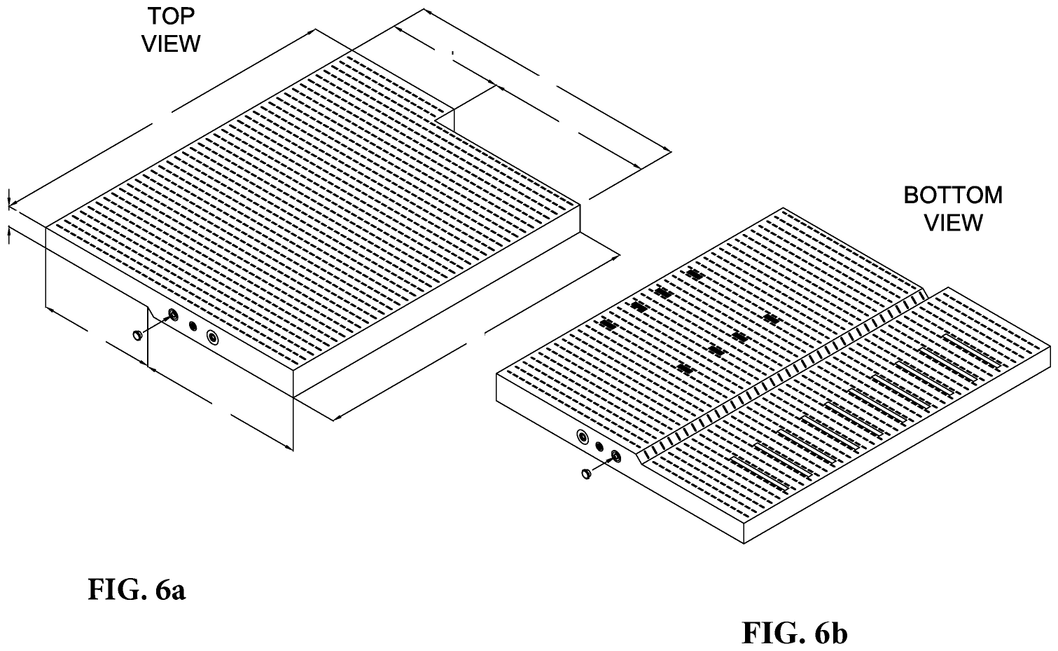

FIG. 7 (a) depicts a top view of a top pad to be used with the top pad depicted in FIG. 8 and (b) depicts a bottom view of a top pad to be used with the top pad depicted in FIG. 8.

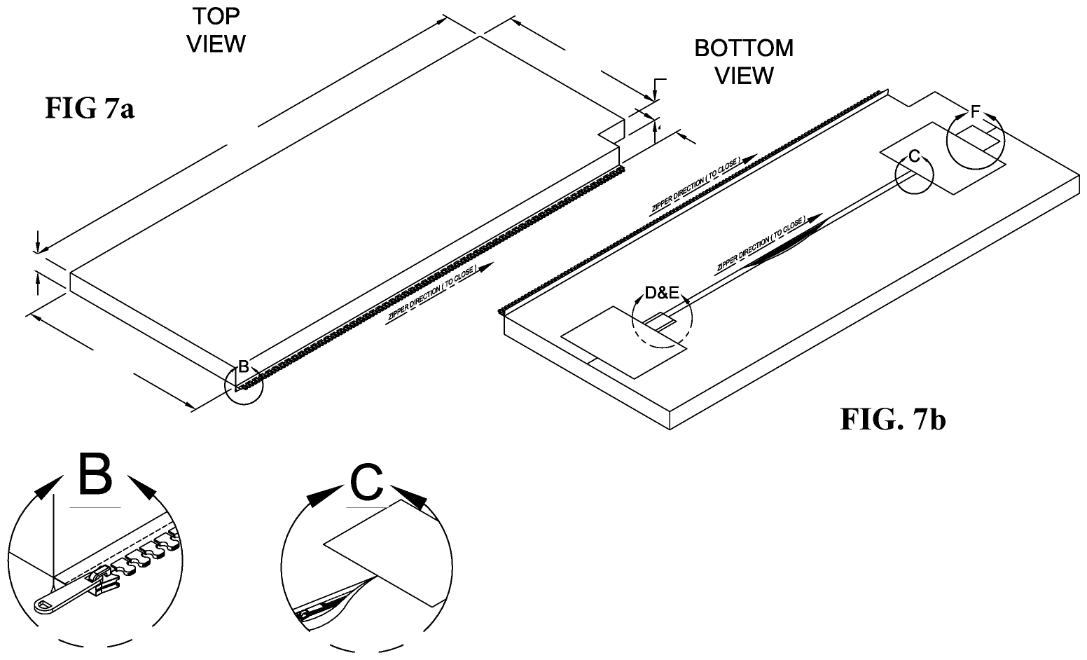

FIG. 8 (a) depicts a top view of a top pad to be used with the top pad depicted in FIG. 7 and (b) depicts a bottom view of a top pad to be used with the top pad depicted in FIG. 7.

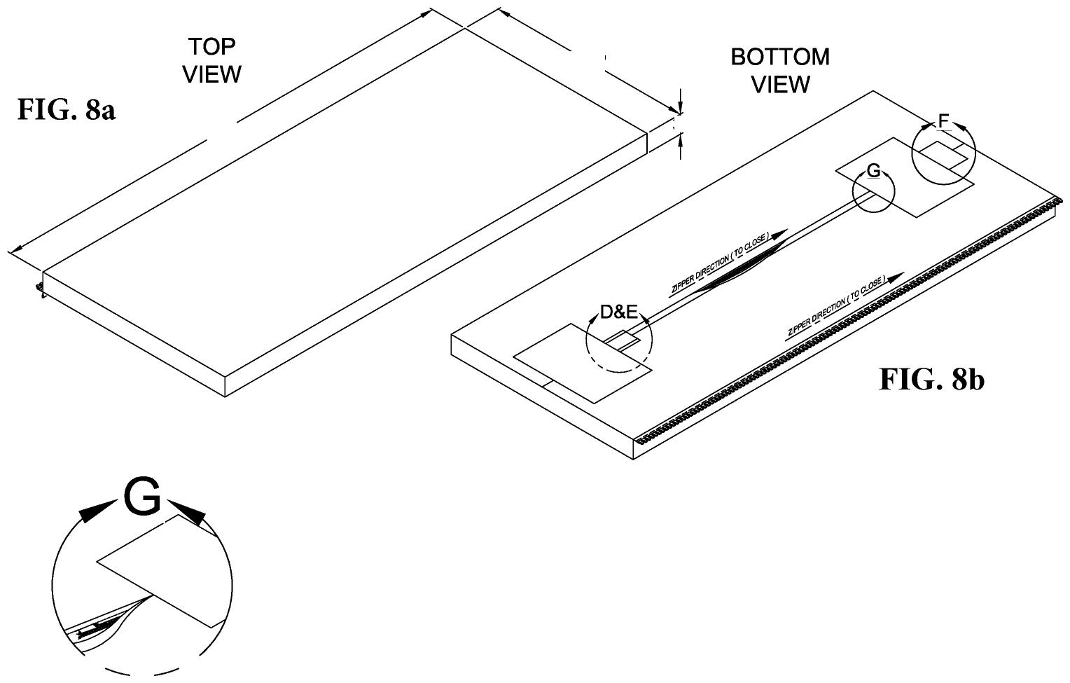

FIG. 9 (a) depicts a bottom view of a filler pad and (b) depicts a top view of a filler pad.

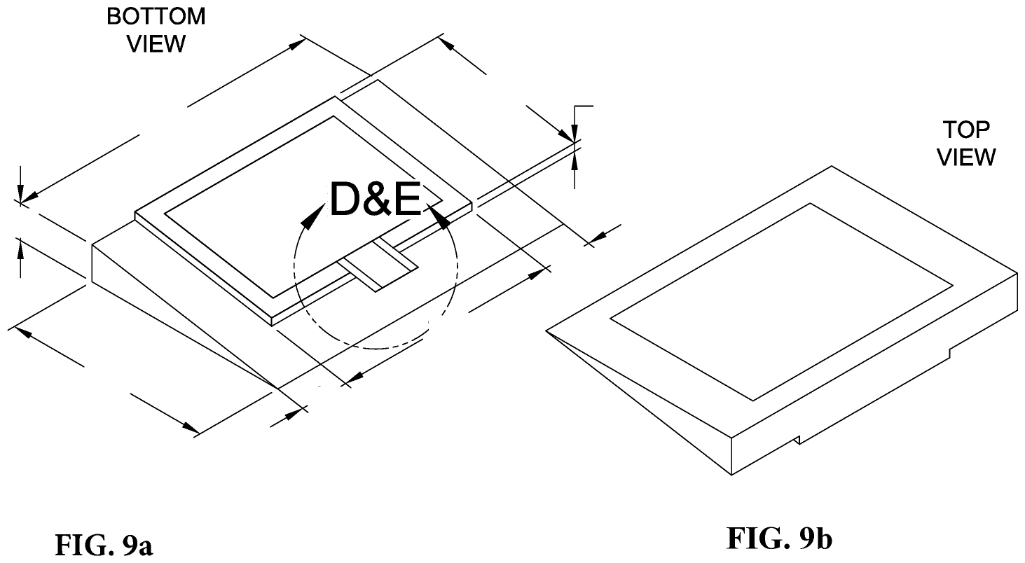

FIG. 10 (a) depicts a back view of a carrying case and (b) depicts a front view of a carrying case.

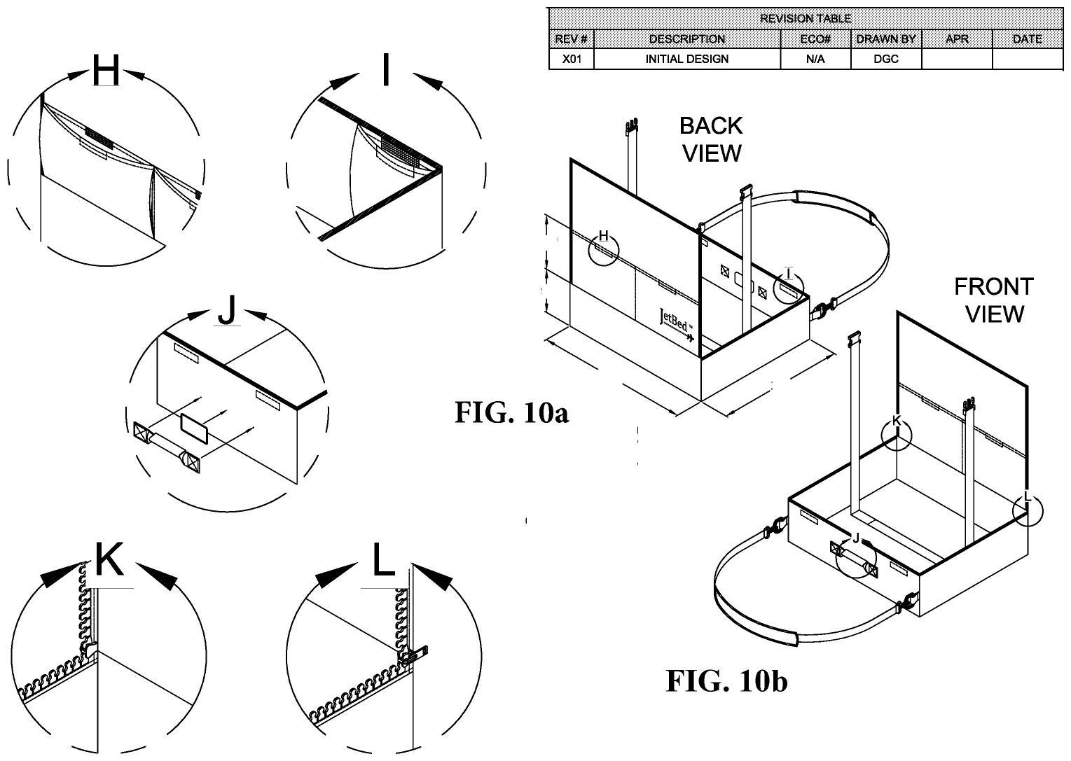

FIG. 11 (a) depicts back view of a carrying case and (b) depicts a front view of a carrying case.

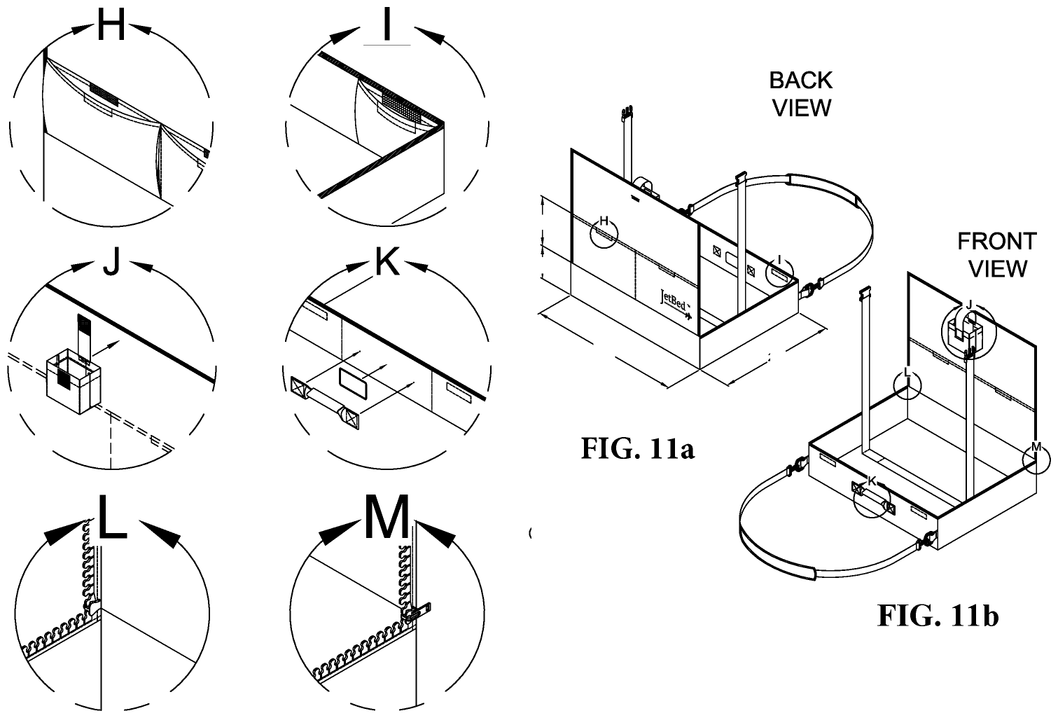

### DETAILED DESCRIPTION OF THE INVENTION

This disclosure, as discussed herein and as shown in the drawings, provides a significant advance on the prior patent mentioned above, by providing a bed concept capable of spanning an aisle of a craft to make a double bed (or larger) supported by seating structures on both sides of the aisle.

Embodiments of the present invention provide devices which quickly and inexpensively transform two seating sections, separated by an aisle, into a horizontal double bed (or larger) surface adapted to provide multiple users with a flat surface upon which to lie on their back, side or stomach. A collapsible foundation block is adapted to form a space filling function as to a space for example, between the face-to-face seats of an aircraft or other craft featuring seating sections separated by an aisle (the aircraft, watercraft, trailers, campers, automotive vehicles, or the like, are collectively referred to herein as “transport craft” or simply “craft”), such that face-to-face seats are secured to a floor section of the craft, thus forming a horizontal surface. The foundation block is preferably inflatable and is supported from a floor surface between the two face-to-face seats, whereafter a supporting structure of the foundation block rises to a top surface generally parallel to the floor. The elevation of the top surface is approximately a level of a top surface of seat cushions or other seat structures, of the two face-to-face seats and/or seating sections across an aisle. A collapsible foundation pad is adapted to span the aisle of the craft forming a double bed. The foundation pad can be supported by the foundation block(s) and seating sections.

The present invention is a device which quickly and inexpensively transforms two seating sections across an aisle into a horizontal double bed or larger surface adapted to provide users with a flat surface upon which multiple users can lie on their back, side or stomach. A collapsible foundation block is adapted to form a space filling function as to a space between two face-to-face seats that are secured to a floor structure forming a horizontal surface. The foundation block is preferably inflatable and is supported from a floor surface between the face-to-face seats, whereafter a supporting structure of the foundation block rises to a top surface generally parallel to the floor. The elevation of the top surface is approximately a level of a top surface of seat cushions of the two face-to-face seats and/or seating sections separated by an aisle.

An inflatable bed surface is adapted to lie across an aisle of a craft with a first and a second seating section. The seating sections can be face-to-face passenger seats or a bench-like seat such as a sofa or a couch. In cases where the first seating section includes face-to-face passenger seats and the second seating section includes a bench-like seat, the foundation block can be placed between the face-to-face passenger seats and the bed surface can lie on the face-to-face seats, the foundation block, and the bench-like seat to span the aisle. In cases where the first seating section and the second seating section each include face-to-face passenger seats, a first foundation block can be placed between the face-to-face passenger seats in the first seating section and a second foundation block can be placed between the face-to-face passenger seats in the second seating section and the bed surface can lie on the face-to-face seats and the foundation blocks to span the aisle. In cases where the first seating section and the second seating section each include a bench-like seat, the bed surface can lie on the bench-like seats to span the aisle. Filler pads can be used to conform to any declination in the seating surfaces of either the bench-like seats or the face-to-face passenger seats.

A bed surface is expected by users to include a generally flat surface from head to feet which is horizontal relative to a floor.

In one form of the bed device, the normal discontinuities and seat declinations found in almost all craft seating are eliminated. A top pad, preferably enclosed in a soft but durable fabric envelope, is attached to the entire top surface of the foundation pad, forming a relatively planar first bed surface parallel to the floor. Adjacent edges of the top pad lie substantially adjacent to an upper elevation of the seat cushions of each seat or other seating surface, i.e., at a front edge of the seat cushion. Connected by hinges or flexible hinge-like attachment to the adjacent edges are connection edges of filler pads. Filler pads are adapted to lie on the top surface of a declination type seat and substantially conform, on an underside, to the declination curvature. A second bed surface of the filler pads is a flat topside and substantially co-planar with the first bed surface. The entire bed surface upon which users can lie on their back, side or stomach consists of a first bed surface of the top pad and two second bed surfaces of the filler pads adjacent to and substantially co-planar with the top pad. The flexible or hinge connection between the top pad and the filler pads eliminates sensed discontinuities in the entire bed surface. In some embodiments, the filler pads are provided separately and are not physically connected to the rest of the bed device.

In another form of the invention, the foundation block includes a generally rectangular shape with a top wall, bottom wall, two end walls (abutting or adjacent to the fronts of the seats), and two side walls. Securing means optionally secures the foundation block to the seats or other seating surface. A form of the securing means uses the existing seat belts of the craft. The device is adapted to use the existing seat belts of the craft to secure the bed surface, or the user and the bed surface to the floor of the craft. The foundation pad and/or top pad can have holes/slits adapted for use with the existing seat belts of the craft. The foundation block can also be secured by the internal air pressure within the foundation block when inflated. The foundation block can be inflated so that the sides of the foundation block are in firm contact with the passenger seats such that the foundation block is wedged in place. Using the existing seat belts in combination with air pressure of the foundation block, it is unnecessary to fix the bottom of the foundation block to the floor in order to obtain a structure sufficiently secure to support the weight of users and thereafter remain in location. Undue side to side shifting of the foundation block is essentially eliminated. However, some embodiments can include securing straps or other adaptations for securing the foundation block in addition to or instead of pressure applied by the foundation block to the adjacent passenger seats. Such embodiments are expressly within the scope of the invention.

A key challenge in making a bed that can span an aisle is the impracticality, in most cases, of having a supporting structure large enough to completely fill all of the aisle space between the seating sections, or to completely run the length of the bed. In the present invention, that challenge is overcome by use of extremely strong and inflatably rigid pneumatic girders or support beams that are provided within the horizontal surface that contacts the supporting structure (e.g., the dotted lines in the drawings). Such support beams are sufficiently rigid, when inflated, to not require direct contact with a supporting structure at all points on the underside of the horizontal surface that are not in contact with either seating structures or the support structure. Such inflatable support beams can be configured within the horizontal surface in locations or with desired rigidity to allow for a significant area of the underside of the horizontal surface to have nothing below it supporting it in such area, while the supporting structure and the seating sections provide the necessary weight-support for the users. Thus, the overall support capacity of the bed is a function of the support provided by (a) the seating surfaces; (b) the supporting structure between the seats (if applicable), and (c) the inflatably rigid support beams.

In some embodiments, different sections of the bed can require different internal air pressures to provide the necessary support and rigidity. Accordingly, in some embodiments of the invention, the thickness of the walls of some sections, and the strength of the construction joining different pieces of the material of which the bed is made, can be adapted and varied based upon the amount of internal air pressure that portion of the bed can be required to sustain. Likewise the placement, spacing, and number of inflatably rigid support beams can be adapted based upon the particular design and needs of the bed.

Actual construction of the bed follows standard protocols in the industry which involve use of a suitable plastic material that is capable of withstanding the necessary pressures applied upon full inflation and use. In some embodiments that plastic material is a blend of ballistic nylon for strength and urethane for air-tightness. Selection of other materials suitable for meeting these dual requirements is within the level of skill in the art. Among the standard industry protocols is precision-cutting the plastic material, which is usually directly connected to and interactive with CAD drawings such that the cutting mechanism is guided by the drawings themselves. Any other approach to cutting the materials is also within the scope of the invention. After the pieces are cut, they are welded together, typically using a radiofrequency welding method that is also standard within the industry. Selection of any other approaches to welding the pieces together to meet the requirements for inflation and use is also within the level of skill in the art.

Embodiments of the invention provide an inflatable foundation pad capable of spanning an aisle between two spaced apart, seating sections, such as are found on commercial jetliner or business jet aircraft, to form a relatively flat surface, including the seat surfaces of the seating sections, to form a bed surface; filler pads which can be flexibly attached to top end edges of the foundation pad that, when the foundation pad is in inflated and in place, extend onto the seat or bench surfaces to provide a more uniform bed surface from one end of the entire bed surface to the other; and a fabric covered, foam top cushion for the foundation pad top surface that is effectively continuous with the tops of the filler pads so that users experience a uniform softness of the bed surface from one end to the other.

Users can lie down securely, with or without a strap or straps about their body, for long periods of time on the bed surface. The foundation block and pad can be deflated and other extensions from it folded into a small volume for compact storage.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

Applicant reserves the right to seek design protection of any portions of the invention that are eligible for design-patent coverage, and as shown in the drawings.

1. A device for forming a bed surface comprising:
(a) an inflatable foundation block comprising a top surface, a bottom surface, two end walls and two side walls, wherein the bottom surface is capable of being supported by a floor surface between two face-to-face passenger seats in a craft, the end walls and side walls rise to support the top surface, the top surface has a width about that of the face-to-face passenger seats, the top surface has a length from a top of one end wall to a top of another end wall and equals about a distance between opposing front edges of the face-to-face passenger seats, and the entire foundation block is adapted to be collapsed in a stowage state and expanded in an installed state, wherein the top surface of the foundation block extends between the opposing front edges of the seat cushions of the passenger seats in the installed state; and
(b) an inflatable foundation pad comprising a top surface, a bottom surface, two end walls and two side walls, wherein the top surface spans an aisle of the craft between the face-to-face passenger seats and a second seating section, wherein the bottom surface of the inflatable foundation pad is capable of being supported by the top surface of the foundation block, top surfaces of the two face-to-face passenger seats, and a top surface of the second seating section.

2. The device of claim 1 wherein the foundation pad is covered with a top pad of uniform thickness.

3. The device of claim 1 wherein the foundation pad is covered with two adjacent top pads.

4. The device of claim 1 wherein the bed surface is at least the size of a double bed.

5. The device of claim 1 wherein the foundation block is capable of supporting weight by way of multiple structure internal baffles.

6. The device of claim 1 wherein the multiple structure internal baffles connect to an inside surface of the top surface, the bottom surface and the side walls.

7. The device of claim 1 wherein the passenger seats comprise an elevated front edge and a back part at a lower elevation, and wherein the device further comprises filler pads and wherein each filler pad has dimensions such that a top surface thereof is substantially co-planar with the top surface of the foundation block when a conforming underside of each filler pad rests upon the passenger seat in the installed state.

8. The device of claim 1 wherein each filler pad is rotatably fixed to each of two edges of the foundation pad which are adjacent to the front edge in the installed state.

9. The device of claim 7 wherein the top pad and filler pad are enclosed in a flexible fabric envelope and are rotatably connected by an integral fabric section.

10. The device of claim 7 wherein each filler pad has a width about equal to face-to-face passenger seat width and has a length about equal to a distance from the front edge to the back part.

11. The device of claim 1 wherein the foundation block and foundation pad are separate units capable of being deflated and stowed in a carrying case with the filler pads; wherein the carrying case comprises a height of less than half of the face-to-face passenger seat.

12. The device of claim 1 wherein the second seating section is a sofa.

13. The device of claim 1 wherein the second seating section is a second set of face-to-face passenger seats and wherein the device comprises a second support block oriented to fit between the seats of said second set.

14. A device for forming a bed surface comprising an inflatable foundation pad comprising a top surface, a bottom surface, two end walls and two side walls, wherein the top surface spans an aisle of a craft, two seating sections on opposite sides of the aisle, wherein the bottom surface of the inflatable foundation pad is capable of being supported by the top surface of the seating surfaces.

15. The device of claim 14 wherein the foundation pad is covered with a top pad of uniform thickness.

16. The device of claim 14 wherein the foundation pad is covered with two adjacent top pads.

17. The device of claim 14 wherein the bed surface is at least the size of a double bed.

18. The device of claim 14 wherein the seating surfaces comprise an elevated front edge and a back part at a lower elevation, and wherein the device further comprises filler pads and wherein each filler pad has dimensions such that a top surface thereof is substantially co-planar with the bottom surface of the foundation pad when a conforming underside of each filler pad rests upon the seating surfaces in the installed state.
